(19) United States
(12) Patent Application Publication
(10) Pub. No.: US 2006/0293618 A1
(43) Pub. Date: Dec. 28, 2006

(54) Massage device for massaging legs and feet simultaneously

(75) Inventor: Wen Hsu Hsieh, Changhua City (TW)

Correspondence Address: CHARLES E. BAXLEY, ESQ., 90 JOHN STREET, THIRD FLOOR, NEW YORK, NY, 10038, US

(73) Assignee: Kuang Yu Metal Working Co., Ltd.

(21) Appl. No.: 11/169,609

(22) Filed: Jun. 28, 2005

(51) Int. Cl. A61H 7/00

(52) U.S. Cl. 601/133; 601/94; 601/90; 601/134

(57) ABSTRACT

A massage device for massaging legs and feet simultaneously comprises: a motor, a gearbox and two massage mechanisms and a seat. The massage mechanisms each is provided with a rotary shaft that rotates under the control of the gearbox. And on the rotary shaft of the respective massage mechanisms is mounted an pulley that rotates in the same direction of the rotary shaft, and a belt is drivingly connected between the pulleys, when the motor rotates, the gearbox will be driven to rotate one of the massage mechanism, and then this massage mechanism will use the belt to rotate the pulley of another one of the massage mechanisms, in this way, the two massage mechanisms will be driven to massage legs and feet simultaneously.

### BACKGROUND OF THE INVENTION

1. Field of the Invention

The present invention relates to a massage device, and more particularly to a massage device that is capable of massaging legs and feet simultaneously.

2. Description of the Prior Arts There are many massage devices that are capable of massaging legs and feet simultaneously, one of them is disclosed by WO2005/023169A1l, as shown in FIG. 1, and generally includes a motor for driving two gearboxes, and the two gearboxes are employed to drive two massage mechanisms to massage legs and feet, simultaneously.

However, in this massage device, the axial shaft of the motor must be long enough in order to drive the two gearboxes disposed at both ends thereof, and the long axial shaft will inevitably increase the cost of the motor.

Furthermore, the two gearboxes are also an additional cost for the massage device.

In addition, the motor and the gearboxes need to be precisely machined and assembled so that they match well with each other, thus adversely affecting the assembly efficiency.

The present invention has arisen to mitigate and/or obviate the afore-described disadvantages.

### SUMMARY OF THE INVENTION

The primary objective of the present invention is to provide a simple-structured massage device for massaging legs and feet simultaneously that is consisted of low cost and easy available belt and pulleys.

A massage device for massaging legs and feet simultaneously in accordance with the present invention comprises: comprises: a motor, a gearbox and two massage mechanisms and a seat. The massage mechanisms each is provided with a rotary shaft that rotates under the control of the gearbox. And on the rotary shaft of the respective massage mechanisms is mounted an pulley that rotates in the same direction of the rotary shaft, and a belt is drivingly connected between the pulleys, when the motor rotates, the gearbox will be driven to rotate one of the massage mechanism, and then this massage mechanism will use the belt to rotate the pulley of another one of the massage mechanisms, in this way, the two massage mechanisms will be driven to massage legs and feet simultaneously.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a conventional massage device for massaging legs and feet simultaneously;

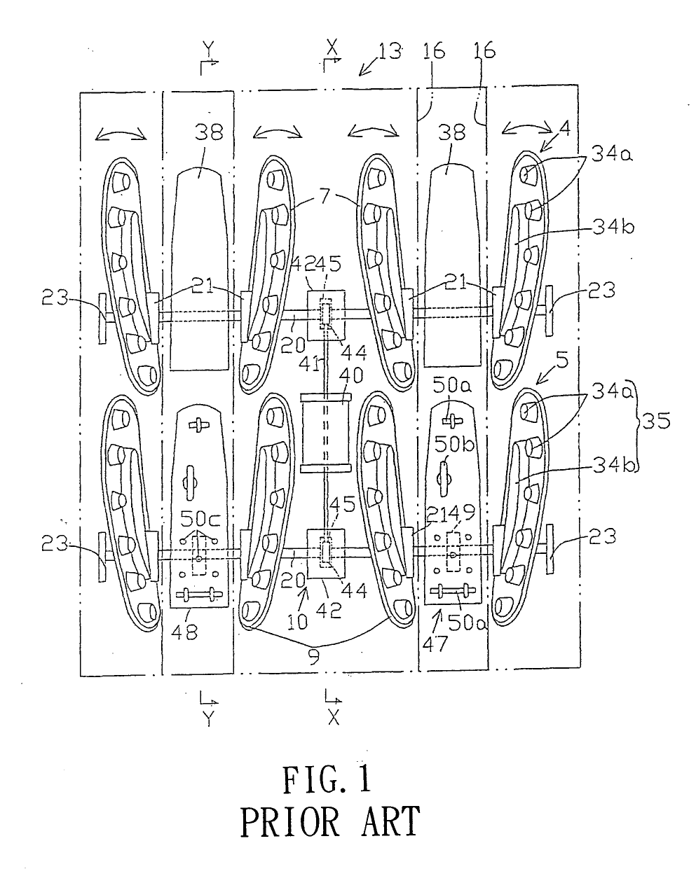

FIG. 2 is an assembly view of showing a massage device for massaging legs and feet simultaneously in accordance with a preferred embodiment of the present invention;

FIG. 3 is a cross sectional view of showing a part of the massage device for massaging legs and feet simultaneously in accordance with the preferred embodiment of the present invention;

FIG. 4 shows the massage device in accordance with the present invention is being used independently.

FIG. 5 shows that the massage device in accordance with the present invention can be mounted on a massage chair 50.

FIG. 6 shows that the massage device in accordance with the present invention is provided on its bottom with a support member.

### DETAILED DESCRIPTION OF THE PREFERRED EMBODIMENTS

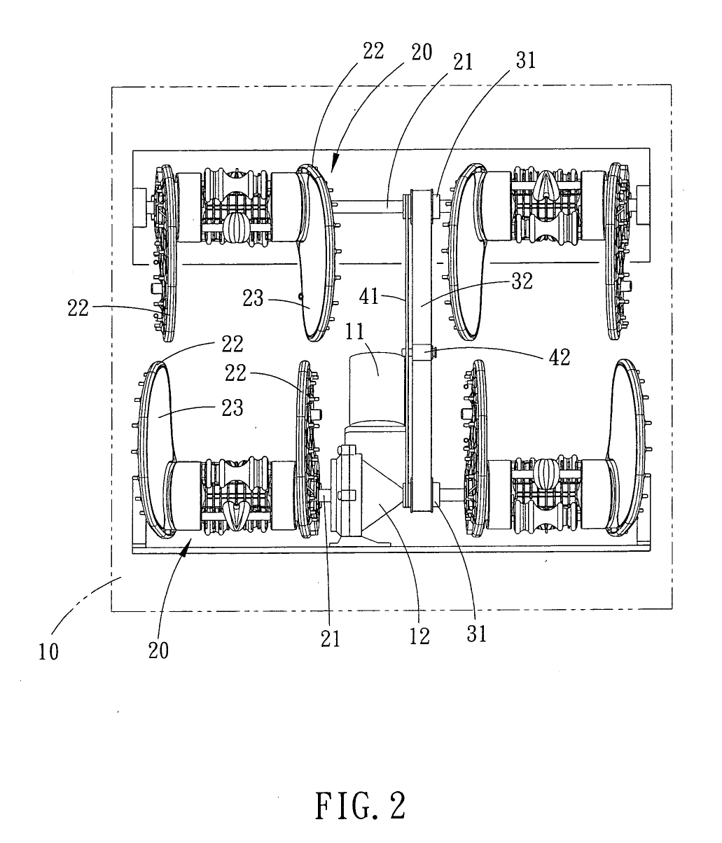

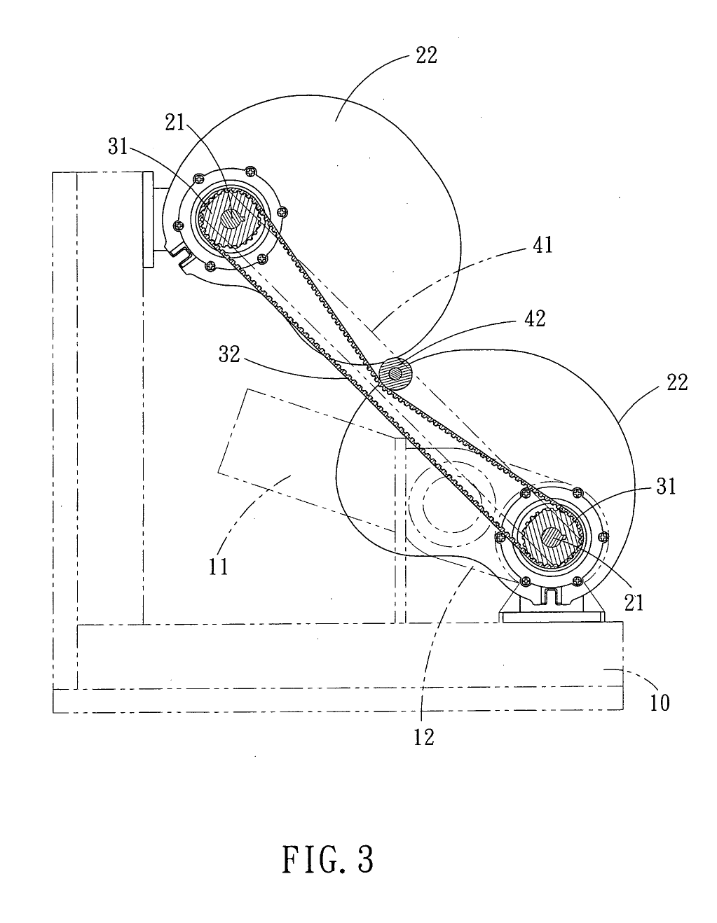

Referring to FIGS. 2 and 3, a massage device for massaging legs and feet simultaneously in accordance with a preferred embodiment of the present invention is shown and comprises: a motor 11, a gearbox 12, two massage mechanisms 20, two pulleys 31, a belt 32, a board 41 and an idler 42 that are disposed on a seat 10.

The seat 10 is provided for mounting the respective components.

The motor 11 is mounted on the gearbox 12 fixed to the seat 10, and the gearbox 12 is driven by the motor 11 and serves to change the speed and the torque of the motor 11.

The massage mechanisms 20 are disposed on the seat 10 and each includes a rotary shaft 21 and four wobble members 22 that serve to massage the legs and feet of a user. One of the massage mechanisms 20 operates under the control of the gearbox 12 (the massage mechanism 20 for massaging the feet for example).

The pulleys 31 are mounted on the rotary shaft 21 of the massage mechanisms 20 and rotate in the same direction as the shaft 21.

The belt 32 is drivingly connected between with the two pulleys 31, and the belt 32 is meshed with the pulleys 31.

The board 41 is disposed between the rotary shafts 21 of the massage mechanisms 20 and located at a side of the belt 32 and the pulleys 31.

The idler 42 is pivotally mounted at a side of the board 41 and presses against a side of the belt 32.

When the motor 11 rotates, the gearbox 12 will be caused to rotate the rotary shaft 21 of the massage mechanism 20 for massaging the user's feet, and then the pulley 31 on this rotary shaft 21 will use the belt 31 to rotate the pulley 31 of another massage mechanism 20 for massaging legs. In this way, the two massage mechanisms 20 can be rotated by the rotary shaft 21 and massage the legs and feet simultaneously.

The pulleys 31 and the belt 32 are cheap and easy available. Furthermore, since the belt 32 is made of plastic material, it is able to absorb the vibration caused during the rotation of the belt 32 and the pulleys 31. Therefore, the device of the present invention is more quite than that of the conventional arts. Besides, the belt and pulley assembly is flexible and easily assembled.

On the other hand, the idler 42 pressing against the belt 32 can prevent sag of the belt after long time of use, without needing to adjust the distance between the pulleys 31.

It will be noted that the wobble members 22 of the massage mechanisms 20 are arranged at a predetermined angle with respect to the rotary shafts 21 (as shown in FIG. 2), so that the wobble members 22 can provide a wavy massage effect. Each of the wobble members 22 is provided with an airbag 23 that will be inflated and deflated during the rotation of the wobble members 22 to provide varying pressures against the legs and feet.

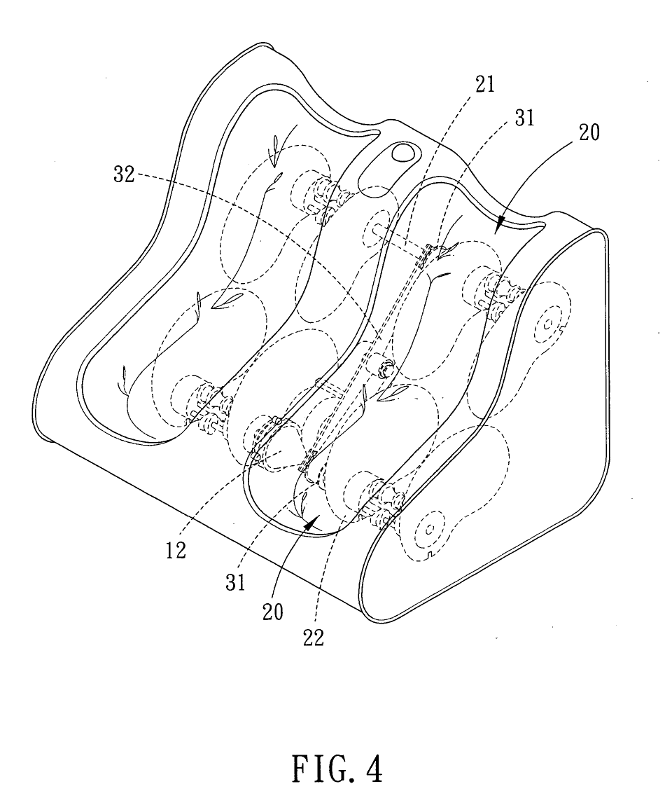

Referring to FIG. 4, which shows the massage device in accordance with the present invention is being used independently.

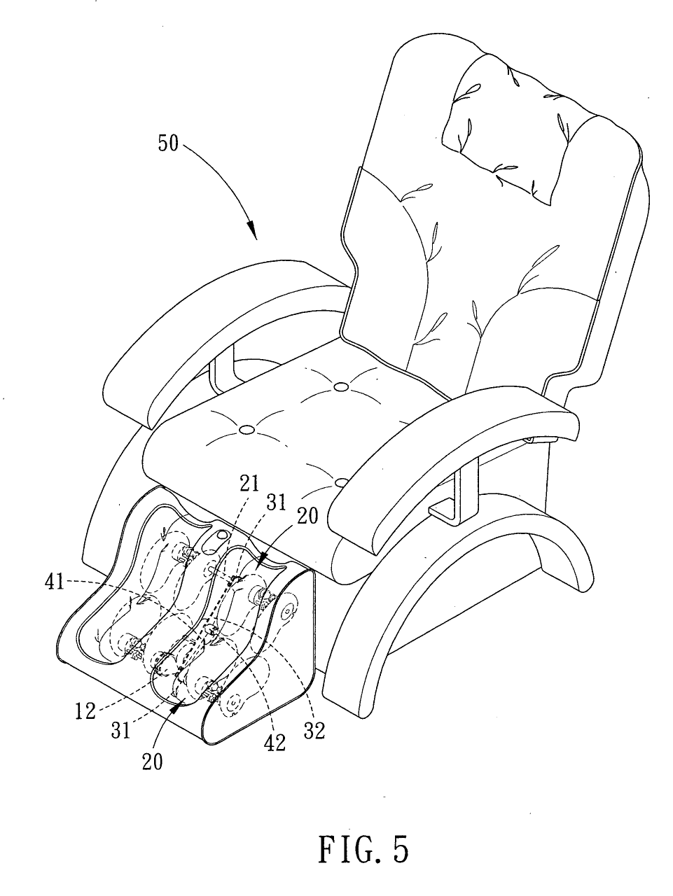

FIG. 5 shows that the massage device in accordance with the present invention can be mounted on a massage chair 50.

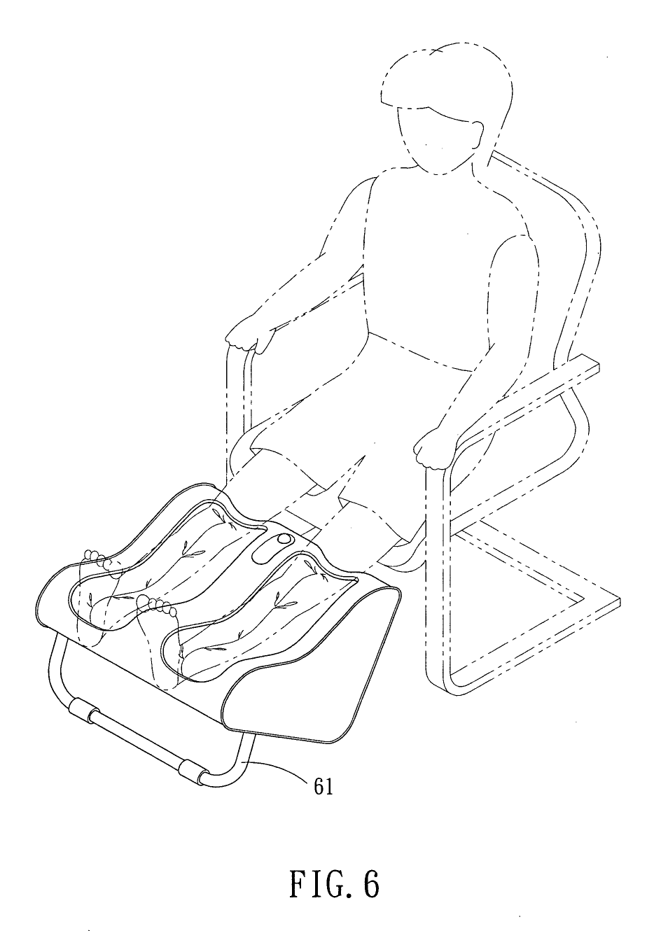

Referring to FIG. 6, the massage device in accordance with the present invention can be provided on the bottom thereof with a support member 61, so that the mounting angle of the massage device can be adjusted properly to provide a more comfortable massage effect.

While we have shown and described various embodiments in accordance with the present invention, it should be clear to those skilled in the art that further embodiments may be made without departing from the scope of the present invention.

What is claimed is:

1. A massage device for massaging legs and feet simultaneously comprising: a motor, a gearbox and two massage mechanisms disposed on a seat, the motor employed to drive the gearbox and the gearbox serving to rotate the massage mechanisms and make them massage legs and feet simultaneously, wherein the massage mechanisms each is provided with a rotary shaft that rotates under the control of the gearbox; and
on the rotary shaft of the respective massage mechanisms is mounted an pulley that rotates in the same direction as the rotary shaft, and a belt is drivingly connected between the pulleys, when the motor rotates, the gearbox will be driven to rotate one of the massage mechanism, and then this massage mechanism will use the belt to rotate the pulley of another one of the massage mechanisms, in this way, the two massage mechanisms will be driven to massage legs and feet simultaneously.

2. The massage device for massaging legs and feet simultaneously as claimed in claim 1, wherein a board is disposed between the rotary shafts of the respective massage mechanisms, and on the board is provided an idler that is used to press against a side of the belt.
